(19) United States
(12) Patent Application Publication
(10) Pub. No.: US 2023/0297642 A1
(43) Pub. Date: Sep. 21, 2023

(54) BEARINGS-ONLY TARGET TRACKING METHOD BASED ON PSEUDO-LINEAR MAXIMUM CORRELATION ENTROPY KALMAN FILTERING

(71) Applicant: UNIVERSITY OF ELECTRONIC SCIENCE AND TECHNOLOGY, CHENGDU (CN)

(72) Inventors: BEI PENG, CHENGDU (CN); SHAN ZHONG, CHENGDU (CN); GANG WANG, CHENGDU (CN); HONGYU ZHANG, CHENGDU (CN); LINQIANG OUYANG, CHENGDU (CN); XINYUE YANG, CHENGDU (CN); XUDONG WEI, CHENGDU (CN); KUN ZHANG, CHENGDU (CN)

(21) Appl. No.: 18/088,634

(22) Filed: Dec. 26, 2022

(30) Foreign Application Priority Data
Mar. 18, 2022 (CN) 202210272651.0

(51) Int. Cl. G06F 17/15; G06F 17/18; G06F 17/16

(52) U.S. Cl. CPC G06F 17/153; G06F 17/18; G06F 17/16

(57) ABSTRACT

The invention discloses a bearings-only target tracking method based on pseudo-linear maximum correlation entropy Kalman filtering, which introduces the correlation entropy function into pseudo-linear Kalman filtering to solve the problem of non-Gaussian noise. A bearings-only target tracking algorithm based on pseudo-linear maximum correlation entropy Kalman filtering is also proposed. The invention combines the maximum correlation entropy theory with pseudo-linear Kalman filtering, and the target tracking accuracy is higher and divergence can be avoided when working in a non-Gaussian environment.

### BACKGROUND OF THE INVENTION

### 1. Technical Field

The invention relates to bearings-only target tracking, in particular to a bearings-only target tracking method based on pseudo-linear maximum correlation entropy Kalman filtering.

### 2. Description of Related Art

The purpose of target tracking is to estimate the position and velocity of a moving target from noise pollution sensor data collected by a single motion sensor or a plurality of spatially distributed sensor nodes. Typical sensor data used for target tracking include azimuth (angle of arrival), time of arrival, time difference of arrival and received signal strength. The invention mainly studies bearings-only target tracking by using a single sensor on a two-dimensional plane.

Bearings-only target tracking is a passive detection method, which is very useful in aerospace, underwater tracking and passive target detection. At present, the research on bearings-only multi-target tracking is very extensive, mostly limited to changing tracking methods and tracking tools though. From the actual needs of target tracking, it is best to study a single-station bearings-only single-target tracking algorithm. This is the simplest way to track, and information is obtained completely from noisy azimuth signals of a target. At present, bearings-only target tracking mainly faces two major problems: non-Gaussian noise and observation equation nonlinearity.

### BRIEF SUMMARY OF THE INVENTION

The purpose of the invention is to overcome the shortcomings of the prior art, and provide a bearings-only target tracking method based on pseudo-linear maximum correlation entropy Kalman filtering, which combines the maximum correlation entropy theory with pseudo-linear Kalman filtering, so that the target tracking accuracy is higher and divergence can be avoided when working in a non-Gaussian environment.

The aim of the invention is realized by the following technical scheme. A bearings-only target tracking algorithm based on pseudo-linear maximum correlation entropy Kalman filtering comprises the following steps:

S1, initializing a noise variance and a state transition matrix, initializing an initial position state \hat{x}_{0|0} of a target, and selecting a proper Gaussian kernel width σ and a convergence determination coefficient εₜ;

S2, linearizing a bearings-only observation equation by using a pseudo-linear method, calculating a prior estimated value \hat{x}_{k|k-1} and a prior covariance matrix P_{k|k-1} of the target to be tracked, at which time a sensor obtains angle information of the target, calculating a weighted value of the prior estimation \hat{x}_{k|k-1} and the angle information according to an unfixed-point iteration formula of a maximum correlation entropy, then updating a posterior estimated value \hat{x}_{k|k,t}, calculating a deviation of pseudo-linear Kalman filtering, and instantly compensating on the posterior estimated value to obtain more accurate target tracking information; and

S3, when an update of the posterior estimated value satisfies the determination coefficient εₜ, stopping updating, calculating a posterior covariance matrix, and starting the next round of iteration.

In this application, bearings-only means that in the process of target tracking, only angle measurement needs to be conducted on the target. Combined with a state transition matrix A, target tracking can be completed.

In S1, for the noise variance and the state transition matrix,

$$\begin{matrix}{Q}_{k} = [ \begin{matrix}{q}_{x} \frac{{T}^{3}}{3} & 0 & {q}_{x} \frac{{T}^{2}}{2} & 0 \\ 0 & {q}_{y} \frac{{T}^{3}}{3} & 0 & {q}_{y} \frac{{T}^{2}}{2} \\ {q}_{x} \frac{{T}^{2}}{2} & 0 & {q}_{x} T & 0 \\ 0 & {q}_{y} \frac{{T}^{2}}{2} & 0 & {q}_{y} T\end{matrix} ] & A = [ \begin{matrix}1 & 0 & T & 0 \\ 0 & 1 & 0 & T \\ 0 & 0 & 1 & 0 \\ 0 & 0 & 0 & 1\end{matrix} ]\end{matrix} ,$$

qₓ and q_{y} are power spectral densities of noise in X axis and Y axis, and T is an iteration time interval; the convergence determination coefficient εₜ is a positive number less than one ten thousandth;

correlation entropy can be described as generalized similarity between two random variables; for variables with joint distribution functions:

H_{XY}=E{K(X,Y)}=ƒK(x,y)dF_{XY}(x,y),

where K(⋅,⋅) represents a scale-invariant Mercer kernel, the scale-invariant Mercer kernel is adopted as a Gaussian kernel, and the formula of the Gaussian kernel is:

$$K ( x , y ) = {G}_{σ} ( x - y ) = exp ( - \frac{{( x - y )}^{2}}{2 {σ}^{2}} ) ,$$

here, σ>0 represents Gaussian kernel width, which is generally set to 1.5. Because a joint probability distribution function F_{XY} is unknown, N samples are used to estimate the correlation entropy Ĥ_{XY} between two variables;

$${\hat{H}}_{XY} = \frac{1}{N} {\sum }_{i = 1}^{N} {G}_{σ} ( {x}_{i} - {y}_{i} ) .$$

Taylor expansion is conducted on the correlation entropy formula:

$${H}_{XY} = {\sum }_{n = 0}^{∞} \frac{{( - 1 )}^{n}}{{2}^{n} {σ}^{2 n} n !} E [ {( X - Y )}^{2 n} ] ,$$

it can be seen that the correlation entropy is a weighted sum of even moments of errors; and because the correlation entropy contains the information of high moments of errors, maximum correlation entropy Kalman filtering has better performance in dealing with non-Gaussian noise.

S2 comprises the following sub-steps:

S201, firstly, giving a bearings-only target positioning model as follows, where xₖ is a velocity state at a target position, \tilde{θ}ₖ is a sensor observation angle, and eₖ is measurement noise;

xₖ=Axₖ₋₁+wₖ₋₁,

\tilde{θ}ₖ=f(xₖ)+eₖ,

where f(xₓ)=tan⁻¹(p_{y,k}−s_{y,k}/p_{x,k}−s_{x,k}) is a nonlinear equation, and using pseudo-linear estimation, a linear form of the observation equation is expressed as:

zₖ=Hₖxₖ+ηₖ,

here zₖ∈R¹,

zₖ=uₖ^{T}sₖ, Hₖ=uₖ^{T}M,

and

$${u}_{k} = [ \begin{matrix}sin \tilde{θ} \\ - cos \tilde{θ}\end{matrix} ] , M = [ \begin{matrix}1 & 0 & 0 & 0 \\ 0 & 1 & 0 & 0\end{matrix} ] , {η}_{k} = - ‖ {r}_{k} ‖ sin {e}_{k} ,$$

here, rₖ=pₖ−sₖ is defined as a vector from the sensor to the target, and symbol ||·|| represents an Euclidean norm; and pseudo-linear noise ηₖ is defined as

$$\begin{matrix}{R}_{k} = E \{ {η}_{k}^{2} \} = {‖ {r}_{k} ‖}^{2} E \{ {sin}^{2} {e}_{k} \} \\ = {‖ {r}_{k} ‖}^{2} \frac{1}{2} ( 1 - exp ( - 2 {σ}_{k}^{2} ) ) \\ \approx {‖ {r}_{k} ‖}^{2} {σ}_{k}^{2}\end{matrix} .$$

therefore, by a pseudo-linear method, the bearings-only target model is converted into

xₖ=Axₖ₋₁+wₖ₋₁,

\tilde{θ}ₖ=f(xₖ+eₖ,

S202, calculating the prior estimated value \hat{x}_{k|k-1} and the prior covariance matrix P_{k|k-1} of the target to be tracked with the following calculation mode:

\hat{x}_{k|k-1}=A\hat{x}_{k-1|k-1},

P_{k|k-1}=AP_{k-1|k-1}A^{T}+Qₖ₋₁,

where \hat{x}_{k-1|k-1} represents the position and velocity of the target to be tracked at the last moment, that is, posterior estimation calculated by an algorithm at the last moment, and the prior estimated value at the current moment is obtained by multiplying \hat{x}_{k-1|k-1} by a target state transition matrix A at the current moment; the covariance matrix refers to a mean square matrix of a state estimation error; the covariance matrix is an identity matrix at the initial moment, and the prior estimated value of target estimation is random, which will converge to a target position with the iteration of the algorithm; and

S203, updating the posterior estimated value \hat{x}_{k|k,t} according to the unfixed-point iteration formula of a maximum correlation entropy:

\hat{x}_{k|k,y}=\hat{x}_{k|k-1}+\tilde{K}ₖ(zₖ−Hₖ\hat{x}_{k|k-1}),

where \tilde{K}ₖ is

$$\{ \begin{matrix}{\tilde{K}}_{k} = {\tilde{P}}_{k \vert k - 1} {{H}_{k}^{T} ( {H}_{k} {\tilde{P}}_{k \vert k - 1} {H}_{k}^{T} + {\tilde{R}}_{k} )}^{- 1} \\ {\tilde{P}}_{k \vert k - 1} = {B}_{p , k \vert k - 1} {\tilde{C}}_{p , k}^{- 1} {B}_{p , k \vert k - 1}^{T} \\ {\tilde{R}}_{k} = {B}_{r , k} {\tilde{C}}_{z , k}^{- 1} {B}_{r , k}^{T} \\ {\tilde{C}}_{p , k} = diag ( {G}_{σ} ( {\tilde{ε}}_{1 , k} ) , {G}_{σ} ( {\tilde{ε}}_{2 , k} ) , {G}_{σ} ( {\tilde{ε}}_{3 , k} ) , {G}_{σ} ( {\tilde{ε}}_{4 , k} ) ) \\ {\tilde{C}}_{z , k} = diag ( {G}_{σ} ( {\tilde{ε}}_{5 , k} ) ) \\ {\tilde{ε}}_{k} = {D}_{k} - {W}_{k} {\hat{x}}_{k \vert k , t - 1}\end{matrix} ;$$

after the posterior estimation \hat{x}_{k|k,t} is calculated, deviation compensation is conducted.

The calculation significance of the deviation of pseudo-linear Kalman filtering is that in a target tracking algorithm based on pseudo-linear Kalman filtering, azimuth noise is injected into the observation equation through pseudo-linear observation, which leads to the correlation between the observation matrix and the observation error. The correlation therebetween will lead to an estimation deviation. Therefore, deviation analysis and instantaneous compensation are needed. The process of deviation compensation comprises:

giving a posterior estimation form of pseudo-linear maximum correlation entropy Kalman filtering:

\hat{x}_{k|k}=\hat{x}_{k|k-1}+P̅_{k|k-1}Hₖ^{T}(HₖP̅_{k|k-1}Hₖ^{T}+R̅ₖ)⁻¹(zₖ−Hₖ\hat{x}_{k|k-1}).

according to matrix inversion lemma,:

(A−UD⁻¹V)⁻¹=A⁻¹+A⁻¹U(D−VA⁻¹U)⁻¹VA⁻¹.

the above formula changes to:

\hat{x}_{k|k}=\hat{x}_{k|k-1}+(P̅_{k|k-1}⁻¹+Hₖ^{T}R̅ₖ⁻¹Hₖ)⁻¹Hₖ^{T}R̅ₖ⁻¹(zₖHₖ\hat{x}_{k|k-1}).

after algebraic operation, the error representation of a real value and the estimation is obtained, which comprises three parts:

\hat{x}ₖ−xₖ=MₖBₖ+Γₖ,

where

Mₖ=(P̅_{k|k-1}⁻¹+Hₖ^{T}R̅ₕ⁻¹Hₖ)⁻¹P̅_{k|k-1}⁻¹A(\hat{x}_{k-1|k-1}−xₖ₋₁),

Bₖ=(P̅_{k|k-1}⁻¹+Hₖ^{T}R̅ₕ⁻¹Hₖ)⁻¹P̅_{k|k-1}⁻¹wₖ₋₁,

Γₖ=(P̅_{k|k-1}⁻¹+Hₖ^{T}R̅ₕ⁻¹Hₖ)⁻¹Hₖ^{T}R̅ₖ⁻¹ηₖ,

although Mₖ contains an error from the estimation at the last moment, no estimation deviation will be generated in pseudo-linear Kalman filtering;

Bₖ is a deviation caused by the correlation between the observation matrix Hₖ and process noise wₖ₋₁, the process noise wₖ₋₁ is so small that it is directly ignored, and Γₖ is a deviation of correlation between the observation matrix Hₖ and pseudo-linear observation noise Bk, which cannot be ignored because it is related to S1;

Γₖ plays an important role in biased estimation, and can make up for the deviation caused by reduction; and after the update of \hat{x}_{k|k,t}, Γₖ is compensated on \hat{x}_{k|k,t} according to the following formula

\hat{x}_{k|k,t}^{BC}=\hat{x}_{k|k,t}+(\tilde{P}_{k|k-1,t} ⁻¹Hₖ^{T}\tilde{R}ₘ⁻¹Hₖ)^{-1×}\tilde{R}ₖ⁻¹ σₖ²M^{T}(M\hat{x}_{k|k,t-1}−sₖ),

where \hat{x}_{k|k,t}^{BC} represents the posterior estimated value after compensation.

When an update of the posterior estimated value satisfies the determination coefficient Et, stopping updating, calculating a posterior covariance matrix, and starting the next round of iteration in S3 specifically comprise: after obtaining \hat{x}_{k|k,t}^{BC} by compensating \hat{x}_{k|k,t} in this round, comparing a value obtained by current updating with the last iteration value \hat{x}_{k|k,t-1}^{BC},and if a result is less than what satisfies the determination coefficient εₜ,

$$\frac{‖ {\hat{x}}_{k \vert k , t}^{BC} - {\hat{x}}_{k \vert k , t - 1}^{BC} ‖}{‖ {\hat{x}}_{k \vert k , t - 1}^{BC} ‖} \leq {ε}_{t} ;$$

stopping this round of unfixed-point iteration and calculating the posterior covariance matrix P_{k|k}^{BC}

P_{k|k}^{BC}=(I−\tilde{K}ₖHₖ)P_{k|k-1}(I−\tilde{K}ₖHₖ)^{T}+\tilde{K}ₖRₖ\tilde{K}ₖ^{T}.

returning to S1 to start a new round of iteration.

The invention has the advantages that the correlation entropy function is introduced into pseudo-linear Kalman filtering to solve the problem of non-Gaussian noise; at the same time, the bias problem of pseudo-linear Kalman filtering is analyzed and compensated in real time, and the bearings-only target tracking algorithm based on pseudo-linear maximum correlation entropy Kalman filtering is proposed. The algorithm has good target tracking performance in the case of non-Gaussian noise, and divergence can be avoided. Due to the adoption of pseudo-linear Kalman filtering, the nonlinear problem existing in the observation equation is decoupled, so that the nonlinear problem is solved.

### BRIEF DESCRIPTION OF THE SEVERAL VIEWS OF THE DRAWINGS

FIG. 1 is a flowchart of a method of the invention;

FIG. 2 is a diagram showing positions of a target and a sensor in an embodiment; and

FIG. 3 shows the results of a simulation experiment in an embodiment.

### DETAILED DESCRIPTION OF THE INVENTION

The technical scheme of the invention will be further described in detail with reference to the accompanying drawings, but the protection scope of the invention is not limited to the following.

One of the challenges of target tracking is the non-Gaussian noise processing of bearings-only measurement data. Kalman and extended algorithms thereof based on the minimum mean square error criterion are used in the bearings-only target tracking field currently, which performs well in a Gaussian noise environment. However, in the actual environment, observation noise is usually Gaussian noise superimposed with other noise, such as impulse signals. In this case, the observation noise becomes heavy-tailed (or impulse) non-Gaussian noise, and the target tracking effect of traditional Kalman filters will deteriorate under this condition. The main reason is that the minimum mean square error criterion is very sensitive to large outliers. Although particle filtering can be applied to non-Gaussian noise, the convergence velocity is slow and calculation is complicated. In recent years, more attention has been paid to the optimization criteria in information theory learning, which links information theory, nonparametric estimation and reconstruction of Hilbert space in a simple and unconventional way. Researchers propose that the correlation entropy loss function has obvious advantages over the mean square error loss function in dealing with non-Gaussian noise problems. The reason is that the expansion of correlation entropy is a weighted sum of even moments of errors. Because the correlation entropy contains the information of high moments of errors, while the mean square error loss function only contains the information of second moments of errors, maximum correlation entropy Kalman filtering has better performance in dealing with non-Gaussian noise.

Another problem of target tracking is to deal with the nonlinear relationship between azimuth measurement and the target motion state (position and velocity of a target), which has been studied for a long time. The famous Stansfield estimator method, which is a weighted least square estimator, is equivalent to maximum likelihood estimation (MLE) proposed by Gavish when measured Gaussian noise is small and the mean value is 0. However, an estimation result obtained by the maximum likelihood estimator is very sensitive to an initial value, thus tending to cause non-convergence of iteration. Later, extended Kalman filtering (EKF) was used for bearings-only target tracking. However, divergence tends to occur when EKF was used. Then, a bearings-only target tracking algorithm based on unscented Kalman filtering (UKF) and particle filter (PF) was adopted, which has the disadvantage of high computational complexity, thus being not suitable for real-time processing. Compared with algorithms such as PF and UKF, a pseudo-linear estimation algorithm has lower complexity, better robustness and similar tracking performance. However, its main disadvantage is the bias problem.

The invention aims to introduce the correlation entropy function into pseudo-linear Kalman filtering to solve the problem of non-Gaussian noise; at the same time, the bias problem of pseudo-linear Kalman filtering is analyzed and compensated in real time, and the bearings-only target tracking algorithm based on pseudo-linear maximum correlation entropy Kalman filtering is proposed. The algorithm has good target tracking performance in the case of non-Gaussian noise, and divergence can be avoided. Due to the adoption of pseudo-linear Kalman filtering, the nonlinear problem existing in the observation equation is decoupled, so that the nonlinear problem is solved.

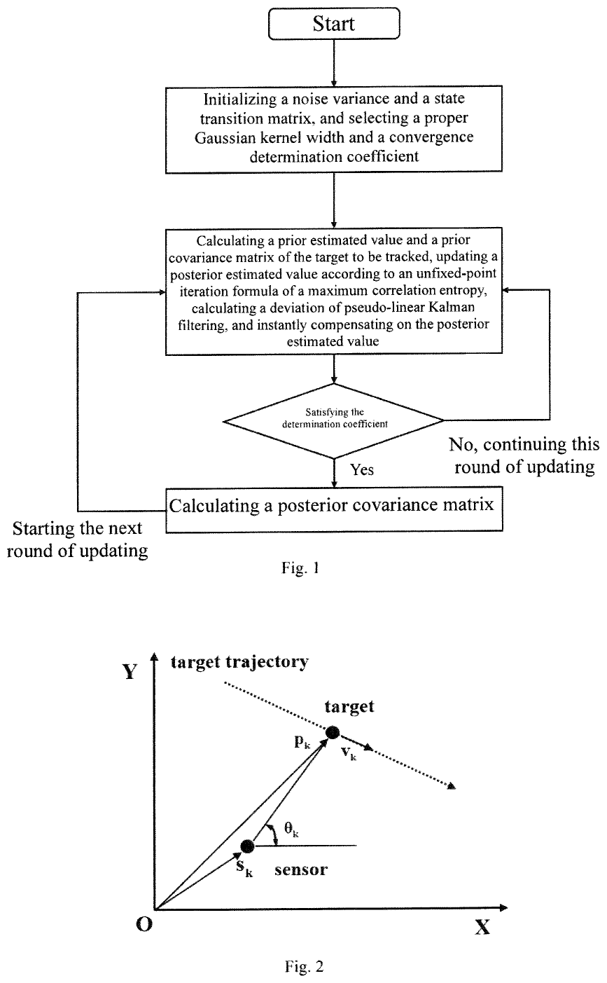

As shown in FIG. 1, a bearings-only target tracking algorithm based on pseudo-linear maximum correlation entropy Kalman filtering comprises the following steps:

S1, initializing a noise variance and a state transition matrix, initializing an initial position state \hat{x}_{0|0} of a target, and selecting a proper Gaussian kernel width σ and a convergence determination coefficient εₜ;

observation noise is non-Gaussian noise, denoted by eₖ˜0.8 N(0, σ_{θ}²*1²)+0.2 N(0, 10²), representing non-Gaussian noise formed by superimposition of 80% small variance Gaussian noise and 20% large variance Gaussian noise; process noise of target movement is expressed as:

$${Q}_{k} = [ \begin{matrix}{q}_{x} \frac{{T}^{3}}{3} & 0 & {q}_{x} \frac{{T}^{2}}{2} & 0 \\ 0 & {q}_{y} \frac{{T}^{3}}{3} & 0 & {q}_{y} \frac{{T}^{2}}{2} \\ {q}_{x} \frac{{T}^{2}}{2} & 0 & {q}_{x} T & 0 \\ 0 & {q}_{y} \frac{{T}^{2}}{2} & 0 & {q}_{y} T\end{matrix} ]$$

where qₓ=0.2 m²/s³, q_{y}=0.2 m²/s³, the state transition matrix is:

$$A = [ \begin{matrix}1 & 0 & T & 0 \\ 0 & 1 & 0 & T \\ 0 & 0 & 1 & 0 \\ 0 & 0 & 0 & 1\end{matrix} ] ,$$

a time interval T is set to 0.1 s, the Gaussian kernel width σ and convergence determination coefficient εₜ are set to 1.5 and 0.000001 respectively;

S2, linearizing a bearings-only observation equation by using a pseudo-linear method, calculating a prior estimated value \hat{x}_{k|k-1} and a prior covariance matrix P_{k|k-1} of the target to be tracked, at which time a sensor obtains angle information of the target, calculating a weighted value of the prior estimation \hat{x}_{k|k-1} and the angle information according to an unfixed-point iteration formula of a maximum correlation entropy, then updating a posterior estimated value \hat{x}_{k|k,t}, calculating a deviation of pseudo-linear Kalman filtering, and instantly compensating on the posterior estimated value to obtain more accurate target tracking information; calculation is conducted in the following way:

\hat{x}_{k|k-1}=A\hat{x}_{k-1|k-1},

P_{k|k-1}=AO_{k-1|k-1}A^{T}+Qₖ₋₁

updating the posterior estimated value Rkikt according to the unfixed-point iteration formula of a maximum correlation entropy comprises the following steps:

\hat{x}_{k|k,t}=\hat{x}_{k|k-1}+\tilde{K}ₖ(zₖ−Hₖ\hat{x}_{k|k-1}),

where \tilde{K}ₖ is

$$\{ \begin{matrix}{\tilde{K}}_{k} = {\tilde{P}}_{k \vert k - 1} {{H}_{k}^{T} ( {H}_{k} {\tilde{P}}_{k \vert k - 1} {H}_{k}^{T} + {\tilde{R}}_{k} )}^{- 1} \\ {\tilde{P}}_{k \vert k - 1} = {B}_{p , k \vert k - 1} {\tilde{C}}_{p , k}^{- 1} {B}_{p , k \vert k - 1}^{T} \\ {\tilde{R}}_{k} = {B}_{r , k} {\tilde{C}}_{z , k}^{- 1} {B}_{r , k}^{T} \\ {\tilde{C}}_{p , k} = diag ( {G}_{σ} ( {\tilde{ε}}_{1 , k} ) , {G}_{σ} ( {\tilde{ε}}_{2 , k} ) , {G}_{σ} ( {\tilde{ε}}_{3 , k} ) , {G}_{σ} ( {\tilde{ε}}_{4 , k} ) ) \\ {\tilde{C}}_{z , k} = diag ( {G}_{σ} ( {\tilde{ε}}_{5 , k} ) ) \\ {\tilde{ε}}_{k} = {D}_{k} - {W}_{k} {\hat{x}}_{k \vert k , t - 1}\end{matrix} ;$$

using pseudo-linear estimation, a linear form of the observation equation is expressed as:

zₖ=Hₖxₖ+ηₖ,

here zₖ∈R¹,

zₖ=uₖ^{T}sₖ, Hₖ=uₖ^{T}M,

and

$${u}_{k} = [ \begin{matrix}sin \tilde{θ} \\ - cos \tilde{θ}\end{matrix} ] , M = [ \begin{matrix}1 & 0 & 0 & 0 \\ 0 & 1 & 0 & 0\end{matrix} ] , {η}_{k} = - ‖ {r}_{k} ‖ sin {e}_{k} ,$$

here rₖ=pₖ−sₖ is defined as a vector from a sensor to a target, and the relationship between the sensor and the target to be tracked is shown in FIG. 2, where Taget represents the target to be tracked, the dotted line represents a target motion trajectory, sₖ represents the position of the sensor, θₖ represents a target angle measured by the sensor, and pₖ and vₖ represent the current position and velocity of the target to be tracked respectively;

symbol ||·|| is Euclidean norm; pseudo-linear noise ηₖ can be defined as

$$\begin{matrix}{R}_{k} = E \{ {η}_{k}^{2} \} = {‖ {r}_{k} ‖}^{2} E \{ {sin}^{2} {e}_{k} \} \\ = {‖ {r}_{k} ‖}^{2} \frac{1}{2} ( 1 - exp ( - 2 {σ}_{k}^{2} ) ) \\ \approx {‖ {r}_{k} ‖}^{2} {σ}_{k}^{2}\end{matrix} .$$

after the update of \hat{x}_{k|k,t}, Γₖ is compensated on \hat{x}_{k|k,t} according to the following formula

\hat{x}_{k|k,t}^{BC}=\hat{x}_{k|k,t}+(\tilde{P}_{k|k-1,t}⁻¹+Hₖ^{T}\tilde{R}ₖ⁻¹Hₖ)⁻¹×\tilde{R}ₖ⁻¹σₖ²M^{T}(M\hat{x}_{k|k,t-1}−sₖ),

where \hat{x}_{k|k,t}^{BC} represents the posterior estimated value after compensation;

S3, when an update of the posterior estimated value satisfies the determination coefficient εₜ, stopping updating, calculating a posterior covariance matrix, and starting the next round of iteration, specifically comprising: after obtaining \hat{x}_{k|k,t}^{BC} by compensating \hat{x}_{k|k,t} in this round, comparing a value obtained by current updating with the last iteration value \hat{x}_{k|k,t-1}^{BC}, and if a result is less than what satisfies the determination coefficient εₜ,

$$\frac{‖ {\hat{x}}_{k \vert k , t}^{BC} - {\hat{x}}_{k \vert k , t - 1}^{BC} ‖}{‖ {\hat{x}}_{k \vert k , t - 1}^{BC} ‖} \leq {ε}_{t} ;$$

stopping this round of unfixed-point iteration and calculating the posterior covariance matrix P_{k|k}^{BC}

P_{k|k}^{BC}=(I−\tilde{K}ₖHₖ)P_{k|k-1}(I−\tilde{K}ₖHₖ)^{T}+\tilde{K}ₖRₖ\tilde{K}ₖ^{T}.

returning to S1 to start a new round of iteration.

In the embodiment of the invention, the total number of iterations is set to 500. In an exemplary experiment, two evaluation indexes are adopted to compare the algorithm of the invention with other algorithms, which are Bnorm index and RMSE index respectively, and their mathematical forms are:

$${BNorm}_{k} = ‖ \frac{1}{N} {\sum }_{i = 1}^{N} ( {\hat{s}}_{k \vert k}^{i} - {s}_{k}^{i} ) ‖ , \\ {RMSE}_{k} = {( \frac{1}{N} {\sum }_{i = 1}^{N} ( {\hat{s}}_{k \vert k}^{i} - {s}_{k}^{i} ) )}^{\frac{1}{2}} ,$$

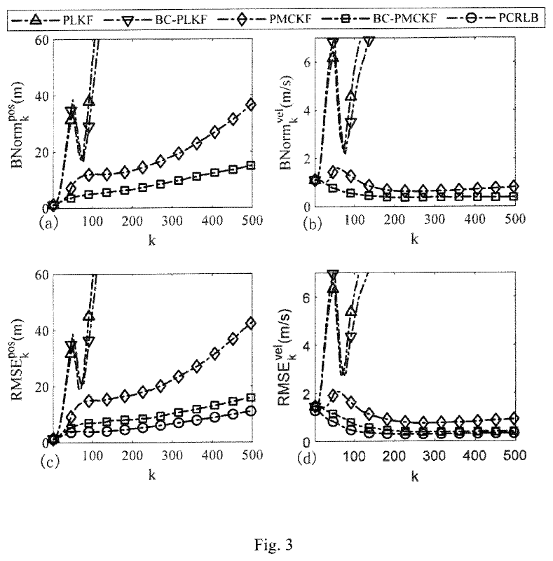

Experimental results are shown in FIG. 3. SC-PMCKF is the curve of the invention, of which an error curve is closest to the lower bound, which indicates that the effect of the algorithm of the invention in the bearings-only target tracking field is superior to that of existing algorithms in terms of the two indexes. FIG. 3 (a) shows a position error (Pos-BNorm) between the estimated value of the algorithm and the actual value of the target. FIG. 3 (b) shows a velocity error (Vel-Norm) between the estimated value of the algorithm and the actual value of the target. It can be seen that the curve SC-PMCKF is closest to the lower bound of a theoretical error. FIG. 3 (c) shows a position error (Pos-RMSE) between the estimated value of the algorithm and the actual value of the target under the RMSE criterion. FIG. 3 (d) shows a velocity error (Vel-RMSE) between the estimated value of the algorithm and the actual value of the target under the RMSE criterion. It can be seen that the curve SC-PMCKF is still closest to the lower bound of the theoretical error.

The above description shows and describes the preferred embodiments of the invention. As mentioned above, it should be understood that the invention is not limited to the forms disclosed herein, should not be regarded as excluding other embodiments, but can be used in various other combinations, modifications and environments, and can be modified by the above teaching or the technology or knowledge in related fields within the scope of the inventive concept described herein. The modifications and changes made by those skilled in the art without departing from the spirit and scope of the invention should be within the scope of protection of the appended claims.

What is claimed is:

1. A bearings-only target tracking method based on pseudo-linear maximum correlation entropy Kalman filtering, comprising the following steps:
S1, initializing a noise variance and a state transition matrix, initializing an initial position state \hat{x}_{0|0} of a target, and selecting a Gaussian kernel width σ and a convergence determination coefficient εₜ;
S2, linearizing a bearings-only observation equation by using a pseudo-linear method, calculating a prior estimated value \hat{x}_{k|k-1} and a prior covariance matrix P_{k|k-1} of the target to be tracked, at which time a sensor obtains angle information of the target, calculating a weighted value of the prior estimation \hat{x}_{k|k-1} and the angle information according to an unfixed-point iteration formula of a maximum correlation entropy, then updating a posterior estimated value \hat{x}_{k|k,t}, calculating a deviation of pseudo-linear Kalman filtering, and instantly compensating on the posterior estimated value to obtain more accurate target tracking information; and
S3, when an update of the posterior estimated value satisfies the determination coefficient εₜ, stopping updating, calculating a posterior covariance matrix, and starting the next round of iteration.

2. The bearings-only target tracking method based on pseudo-linear maximum correlation entropy Kalman filtering according to claim 1, wherein for the noise variance and state transition matrix in S1,
$$\begin{matrix}{Q}_{k} = [ \begin{matrix}{q}_{x} \frac{{T}^{3}}{3} & 0 & {q}_{x} \frac{{T}^{2}}{2} & 0 \\ 0 & {q}_{y} \frac{{T}^{3}}{3} & 0 & {q}_{y} \frac{{T}^{2}}{2} \\ {q}_{x} \frac{{T}^{2}}{2} & 0 & {q}_{x} T & 0 \\ 0 & {q}_{y} \frac{{T}^{2}}{2} & 0 & {q}_{y} T\end{matrix} ] & A = [ \begin{matrix}1 & 0 & T & 0 \\ 0 & 1 & 0 & T \\ 0 & 0 & 1 & 0 \\ 0 & 0 & 0 & 1\end{matrix} ]\end{matrix} ,$$
qₓ and q_{y} are power spectral densities of noise in X axis and Y axis, and T is an iteration time interval; the convergence determination coefficient εₜ is set to be a positive number less than one ten thousandth;
correlation entropy is described as generalized similarity between two random variables; for variables with joint distribution functions:
H_{XY}=E{K(X,Y)}=ƒk(x,y)dF_{XY}(x,y),
where k(⋅,⋅) represents a scale-invariant Mercer kernel, the scale-invariant Mercer kernel is adopted as a Gaussian kernel, and the formula of the Gaussian kernel is:
$$k ( x , y ) = {G}_{σ} ( x - y ) = exp ( - \frac{{( x - y )}^{2}}{2 {σ}^{2}} ) ,$$
where the Gaussian kernel width a σ>0 is set; because a joint probability distribution function F_{XY} is unknown, N samples are used to estimate the correlation entropy Ĥ_{XY} between two variables;
$${\hat{H}}_{XY} = \frac{1}{N} {\sum }_{i = 1}^{N} {G}_{σ} ( {x}_{i} - {y}_{i} ) .$$
Taylor expansion is conducted on the correlation entropy formula:
$${H}_{XY} = {\sum }_{n = 0}^{∞} \frac{{( - 1 )}^{n}}{{2}^{n} {σ}^{2 n} n !} E [ {( X - Y )}^{2 n} ] ,$$
the correlation entropy is a weighted sum of even moments of errors; and because the correlation entropy contains the information of high moments of errors, maximum correlation entropy Kalman filtering has better performance in dealing with non-Gaussian noise.

3. The bearings-only target tracking method based on pseudo-linear maximum correlation entropy Kalman filtering according to claim 1, wherein S2 comprises the following sub-steps:
S201, firstly, giving a bearings-only target positioning model as follows, where xₖ is a velocity state at a target position, \tilde{θ}ₖ is a sensor observation angle, and eₖ is measurement noise;
xₖ=Axₖ₋₁+wₖ₋₁,
\tilde{θ}ₖ=f(xₖ)+eₖ,
where f(xₓ)=tan⁻¹(p_{y,k}−s_{y,k}/p_{x,k}−s_{x,k}) is a nonlinear equation, and using pseudo-linear estimation, a linear form of the observation equation is expressed as:
zₖ=Hₖxₖ+ηₖ,
here zₖ∈R¹,
zₖ=uₖ^{T}sₖ, Hₖ=uₖ^{T}M,
and
$${u}_{k} = [ \begin{matrix}sin \tilde{θ} \\ - cos \tilde{θ}\end{matrix} ] , M = [ \begin{matrix}1 & 0 & 0 & 0 \\ 0 & 1 & 0 & 0\end{matrix} ] , {η}_{k} = - ‖ {r}_{k} ‖ sin {e}_{k} ,$$
here, rₖ=pₖ−sₖ is defined as a vector from the sensor to the target, and symbol ||·|| represents an Euclidean norm; and pseudo-linear noise ηₖ is defined as
$$\begin{matrix}{R}_{k} = E \{ {η}_{k}^{2} \} = {‖ {r}_{k} ‖}^{2} E \{ {sin}^{2} {e}_{k} \} \\ = {‖ {r}_{k} ‖}^{2} \frac{1}{2} ( 1 - exp ( - 2 {σ}_{k}^{2} ) ) \\ \approx {‖ {r}_{k} ‖}^{2} {σ}_{k}^{2}\end{matrix} .$$
therefore, by a pseudo-linear method, the bearings-only target model is converted into
xₖ=Axₖ₋₁+wₖ₋₁,
\tilde{θ}ₖ=f(xₖ+eₖ,
S202, calculating the prior estimated value \hat{x}_{k|k-1} and the prior covariance matrix P_{k|k-1} of the target to be tracked with the following calculation mode:
\hat{x}_{k|k-1}=A\hat{x}_{k-1|k-1},
P_{k|k-1}=AP_{k-1|k-1}A^{T}+Qₖ₋₁,
where \hat{x}_{k-1|k-1} represents the position and velocity of the target to be tracked at the last moment, that is, posterior estimation calculated by an algorithm at the last moment, and the prior estimated value at the current moment is obtained by multiplying \hat{x}_{k-1|k-1} by a target state transition matrix A at the current moment; the covariance matrix refers to a mean square matrix of a state estimation error; the covariance matrix is an identity matrix at the initial moment, and the prior estimated value of target estimation is random, which will converge to a target position with the iteration of the algorithm; and
S203, updating the posterior estimated value \hat{x}_{k|k,t} according to the unfixed-point iteration formula of a maximum correlation entropy:
\hat{x}_{k|k,y}=\hat{x}_{k|k-1}+\tilde{K}ₖ(zₖ−Hₖ\hat{x}_{k|k-1}),
where \tilde{K}ₖ is
$$\{ \begin{matrix}{\tilde{K}}_{k} = {\tilde{P}}_{k \vert k - 1} {{H}_{k}^{T} ( {H}_{k} {\tilde{P}}_{k \vert k - 1} {H}_{k}^{T} + {\tilde{R}}_{k} )}^{- 1} \\ {\tilde{P}}_{k \vert k - 1} = {B}_{p , k \vert k - 1} {\tilde{C}}_{p , k}^{- 1} {B}_{p , k \vert k - 1}^{T} \\ {\tilde{R}}_{k} = {B}_{r , k} {\tilde{C}}_{z , k}^{- 1} {B}_{r , k}^{T} \\ {\tilde{C}}_{p , k} = diag ( {G}_{σ} ( {\tilde{ε}}_{1 , k} ) , {G}_{σ} ( {\tilde{ε}}_{2 , k} ) , {G}_{σ} ( {\tilde{ε}}_{3 , k} ) , {G}_{σ} ( {\tilde{ε}}_{4 , k} ) ) \\ {\tilde{C}}_{z , k} = diag ( {G}_{σ} ( {\tilde{ε}}_{5 , k} ) ) \\ {\tilde{ε}}_{k} = {D}_{k} - {W}_{k} {\hat{x}}_{k \vert k , t - 1}\end{matrix} ;$$
after the posterior estimation \hat{x}_{k|k,t} is calculated, deviation compensation is conducted.

4. The bearings-only target tracking method based on pseudo-linear maximum correlation entropy Kalman filtering according to claim 3, wherein the deviation compensation process comprises:
giving a posterior estimation form of pseudo-linear maximum correlation entropy Kalman filtering:
\hat{x}_{k|k}=\hat{x}_{k|k-1}+P̅_{k|k-1}Hₖ^{T}(HₖP̅_{k|k-1}Hₖ^{T}+R̅ₖ)⁻¹(zₖ−Hₖ\hat{x}_{k|k-1}).
according to matrix inversion lemma,:
(A−UD⁻¹V)⁻¹=A⁻¹+A⁻¹U(D−VA⁻¹U)⁻¹VA⁻¹.
the above formula changes to:
\hat{x}_{k|k}=\hat{x}_{k|k-1}+P̅_{k|k-1}Hₖ^{T}(HₖP̅_{k|k-1}Hₖ^{T}+R̅ₖ)⁻¹(zₖ−Hₖ\hat{x}_{k|k-1}).
after algebraic operation, the error representation of a real value and the estimation is obtained, which comprises three parts:
\hat{x}ₖ−xₖ=MₖBₖ+Γₖ,
where
Mₖ=(P̅_{k|k-1}⁻¹+Hₖ^{T}R̅ₕ⁻¹Hₖ)⁻¹P̅_{k|k-1}⁻¹A(\hat{x}_{k-1|k-1}−xₖ₋₁),
Bₖ=(P̅_{k|k-1}⁻¹+Hₖ^{T}R̅ₕ⁻¹Hₖ)⁻¹P̅_{k|k-1}⁻¹wₖ₋₁,
Γₖ=(P̅_{k|k-1}⁻¹+Hₖ^{T}R̅ₕ⁻¹Hₖ)⁻¹Hₖ^{T}R̅ₖ⁻¹ηₖ,
although Mₖ contains an error from the estimation at the last moment, no estimation deviation will be generated in pseudo-linear Kalman filtering;
Bₖ is a deviation caused by the correlation between the observation matrix Hₖ and process noise wₖ₋₁, the process noise wₖ₋₁ is so small that it is directly ignored, and Γₖ is a deviation of correlation between the observation matrix Hk and pseudo-linear observation noise ηₖ;
Γₖ plays an important role in biased estimation, and can make up for the deviation caused by reduction; and after the update of \hat{x}_{k|k,t}, Γₖ is compensated on \hat{x}_{k|k,t} according to the following formula
\hat{x}_{k|k,t}^{BC}=\hat{x}_{k|k,t}+(\tilde{P}_{k|k-1,t}⁻¹+Hₖ^{T}\tilde{R}ₖ⁻¹Hₖ)⁻¹×\tilde{R}ₖ⁻¹σₖ²M^{T}(M\hat{x}_{k|k,t-1}−sₖ),
where \hat{x}_{k|k,t}^{BC} represents the posterior estimated value after compensation.

5. The bearings-only target tracking method based on pseudo-linear maximum correlation entropy Kalman filtering according to claim 4, wherein S3 comprises
after obtaining \hat{x}_{k|k,t}^{BC} by compensating \hat{x}_{k|k,t}, comparing \hat{x}_{k|k,t}^{BC} obtained by current updating with the last iteration value \hat{x}_{k|k,t-1}^{BC} and if a result is less than what satisfies the determination coefficient εₜ,
$$\frac{‖ {\hat{x}}_{k \vert k , t}^{BC} - {\hat{x}}_{k \vert k , t - 1}^{BC} ‖}{‖ {\hat{x}}_{k \vert k , t - 1}^{BC} ‖} \leq {ε}_{t} ;$$
stopping this round of unfixed-point iteration and calculating the posterior covariance matrix P_{k|k}^{BC}
P_{k|k}^{BC}=(I−\tilde{K}ₖHₖ)P_{k|k-1}(I−\tilde{K}ₖHₖ)^{T}+\tilde{K}ₖRₖ\tilde{K}ₖ^{T}.
returning to S1 to start a new round of iteration.
